(19) United States
(12) Patent Application Publication
(10) Pub. No.: US 2021/0028922 A1
(43) Pub. Date: Jan. 28, 2021

(54) METHODS AND SYSTEMS FOR BLOCKCHAIN SECURED DYNAMIC LOGIC SYSTEM FOR DYNAMIC ON A CHIP (DLSoC) PROCESSOR AND SOFT CODE ECOSYSTEM

(71) Applicant: Concertal Systems, Inc., ALLEN, TX (US)

(72) Inventor: ROBERT CHARLES LEDZIUS, Parker, TX (US)

(21) Appl. No.: 16/518,934

(22) Filed: Jul. 22, 2019

(51) Int. Cl. H04L 9/06; G06F 21/72

(52) U.S. Cl. CPC H04L 9/0637; G06F 21/72

(57) ABSTRACT

A blockchain with packet contents comprised of upstream links for guaranteed provenance of workflow, downstream links for post token generation dynamic content inclusion, and private and public date container content. A dynamic logic processor comprised of embedded FPGA IP and application processor able to accept application software and soft hardware programs with key HASH codes for authenticating provenance of hardware and programs through the use of a development and supply flow blockchain.

### CROSS REFERENCE TO RELATED APPLICATIONS

This application further claims the benefit of the following non-provisional application which is here expressly incorporated by reference:

Application Ser. No. 15/878,342 entitled “METHODS AND SYSTEMS FOR SYSTEM DESIGN AUTOMATION (SDA) OF MIXED SIGNAL ELECTRONIC CIRCUITRY INCLUDING EMBEDDED SOFTWARE DESIGNS,” filed on Jan. 23, 2018 with Attorney Docket No. CONC001US0.

### FIELD OF THE DISCLOSURE

The present disclosure generally relates to methods and systems for dynamic logic system on chip (DLSoC) type of integrated circuit able to partially and securely reconfigure embedded field programmable gate array (eFPGA) chiplets. DLSoC is able to accept, load, and run multi-tasking software (SW) and ‘soft’ hardware (S-HW) application code on demand without interrupting the operation of other active SW and S-HW processes.

### BACKGROUND

Programs such as the CHIPS (Common Heterogeneous Integration and Intellectual Property Reuse Strategies), SDH (Software Defined Hardware), and DSSoC (Domain Specific System on Chip) seek to establish a new paradigm in IP reuse and community ecosystem, build runtime-reconfigurable hardware and software that enables ASIC performance without sacrificing programmability, and develop SoC comprised of many cores in a single programmable device. These research thrusts, being significantly funded through DARPA ERI efforts, are meant to address the $400 B semiconductor industry unprecedented difficulties relating to the continued increased design complexities of integrated circuits.

Micro-processing units (MPUs) often coexist within field programmable gate array (FPGA) chips. FPGA may contain embedded MPUs, or FPGAs may be used as board level peripherals to MPUs. Such systems are plagued with problems, such as:
interrupted SW or HW operation during FPGA configuration
may not not handle loadable application code
are not able to incrementally configure FPGA HW IP combinations without custom configuration redesign and compilation
are missing authentication and validation of loaded SW/HW application code, and anti-tamper protections
Require complex RTOS software to manage SW/HW data flow

Recently eFPGA IP providers are making it possible for SoC and ASIC developers to embed FPGA functionality into their designs. Even these SoC parts require complex integration and software development if the stated issues are to be addressed. Early implementation of such devices do not incorporate integrated methods of operation that enable a simplified method of ‘load and go’ eFPGA HW object integration and operation. A need exists for the implementation of a chip that can solve these complex application development and operational issues in an simplified application IP and use way.

This invention uses the benefits of Concertal's system design automation (SDA technology) to provide simplified solutions and available ecosystem to these problems.

### BRIEF SUMMARY

The disclosed subject matter provides methods and systems for using Concertal's previously disclosed system design automation (SDA) invention in the design generation and operation of a Dynamic Logic SoC (DLSoC) integrated circuit (IC). DLSoC is able to accept, load, and run multi-tasking software (SW) and ‘soft’ hardware (S-HW) application code on demand without interrupting the operation of other active SW and S-HW processes. DLSoC incorporates the use of embedded field programmable gate array (eFPGA) chiplets as SDA integrated functional IP blocks that are able to be securely and partially reconfigured on demand. The DLSoC dynamic logic array subsystems are shown partitioned so that they may be easily added to existing common processor topologies through a SDA bridge, providing self-managed S-HW capabilities to existing application processor environments. SDA architecture and operation method features, inherent in the functional IP integration fabric, greatly simplify the development, deployment, availability, and use of ‘soft’ HW (S-HW) object code. All these elements enable an ability to distribute and use ‘runtime ready’ HW as soft application program IP without requiring any additional development effort for HW IP end users. Existing SW distribution and use business models are able to be extended to HW functionality through the use of DLSoC processors, without sacrificing backward compatibility to existing application software systems and ecosystems.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGUREs and examples are not meant to limit the scope of the present subject matter to a single embodiment, but other embodiments are possible by way of interchange of some or all of the described or illustrated elements and, further, wherein:

FIG. 1 shows DLSoC Implementation Features and runtime ready SW/HW code flow with Authentication site according to the teachings of the present disclosure;

FIG. 2 shows DLSoC simplified topology block diagram according to the teachings of the present disclosure;

FIG. 3 shows DLSoC physical chip floorplan topology example as within the presently disclosed subject matter.

FIG. 4 shows eFPGA SDA Subsystem simplified block diagram example with illustrated relocatable expanded soft-HW object as may be implemented in the present disclosure;

FIG. 5 shows a table showing possible DLSoC eFPGA capacity specifications;

FIG. 6 shows example eWLP package footprint for a DLSoC part;

FIG. 7 shows DLSoC SbC (System Beyond Chip) illustration;

FIG. 8 shows IP Authentication, Verification, and Anti-Tamper validation flow using a Trusted IP Management site within the scope of the disclosed and claimed subject matter;

FIG. 9 shows blockchain database packets containing typical blockchain HASH token, timestamp, description, and additional information element packet contents;

FIG. 10 shows the hardware device supply chain keys and device authentication flow relationships with the blockchain database;

FIG. 11 shows the DLSoC processor chip being used as a highly functional interposer chip for 2.5/3D manufacturing use with chiplets to implement integrated SiP (System in Package) solutions

### DETAILED DESCRIPTION OF ILLUSTRATIVE EMBODIMENTS

The detailed description set forth below in connection with the appended drawings is intended as a description of exemplary embodiments in which the presently disclosed process may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

Provided are novel methods and systems for DLSoC of processing software and/or/with hardware application code that may be generated with Concertal's SDA SoC generation invention. Reference will now be made in detail to the example embodiment illustrated in the accompanying drawings. While the disclosed subject matter will be described in conjunction with the embodiment below, it will be understood that it is not intended to limit the disclosed subject matter to this embodiment and examples.

On the contrary, the disclosed subject matter is intended to cover alternatives, modifications and equivalents, which may be included within the spirit and scope of the disclosed subject matter as defined by the appended claims. Furthermore, in the following detailed description of the present disclosed subject matter, numerous specific details are set forth in order to more fully illustrate the present disclosed subject matter. However, it will be apparent to one of ordinary skill in the prior art that the present disclosed subject matter may be practiced without these specific details. In other instances, well-known methods and procedures, components and processes have not been described in detail so as not to unnecessarily obscure aspects of the present disclosed subject matter.

It will, of course, be appreciated that in the development of any such actual implementation, numerous implementation-specific decisions must be made to achieve the developer's specific goals, such as compliance with application and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The method and system of the present disclosure enable the ability to design and build a general application processor that is able to run application SW and S-HW using eFPGA IPs. SW code may be loaded into the main application processor as is well understood in the industry, and S-HW code may be passed through the SDA fabric to any available eFPGA IP resources on the chip. Data to and from instantiated S-HW IP flows through the SDA fabric using source based address tags, enabling collaborative functional integration with other chip resources to be self managed through data flow sink configuration settings. An important feature of the DLSoC operation is an ability to incrementally load S-HW configurations into any of the available DLA IPs on demand without affecting other SW or S-HW application processes that may be running. An additional feature is that application SW and/or S-HW code may be loaded or embedded in an encrypted form, and the code authenticated and validated using a trusted IP authentication site.

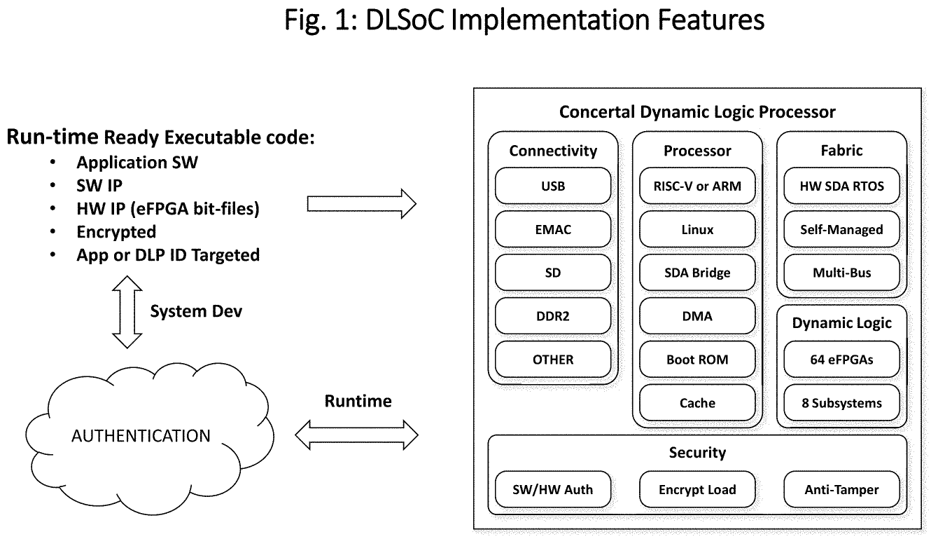

FIG. 1 illustrates the features included in the example embodiment for descriptive purposes. The DLSoC shown illustrates commonly available application processing features, including multiple connectivity interfaces such as universal serial bus (USB), ethernet media access controller (EMAC), Secure Digital (SD), DDR2 for external memory expansion, or other ways to connect with the device. Processor related features include a main processor for running application software may include a common operating system (OS) such as Linux, and a DMA controller that bridges to memory and peripheral subsystems, boot ROM, and on chip CACHE memory. Added features to a common software processing platform include a bridge to an SDA based array of eFPGA chiplets. The SDA interconnect fabric networks all eFPGA together, with data communication between S-HW processing simply being configured to be used where desired. The number of eFPGA chiplets that may be integrated is limited by available die area, but SDA provides a means to scale without limits when utilizing system beyond chip (SbC) features. Since the use of eFPGA chiplets may be dynamically managed, final test failures of eFPGA chiplets can simply be disabled from use, greatly improving production yields or automatically dealing with post shipment of in-field failures. Security features enable the protection of run code against unauthorized access or reverse engineering.

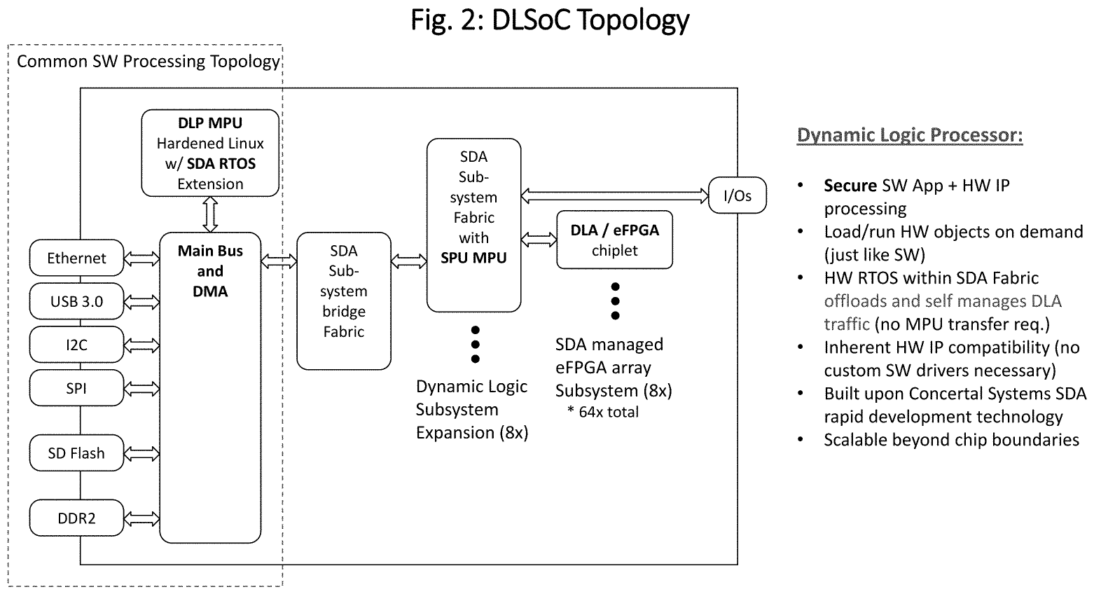

Although SDA enables the ability to put a processor IP anywhere within the fabric structure, the preferred embodiment in FIG. 2 shows the application processor at the top level to illustrate one way to easily retrofit an SDA subsystem into an existing processor chip architecture. SDA subsystems may include any available IPs, but this description concentrates on incorporating dynamically configurable eFPGA IP for use within a regular structure.

Additional DLSoC processor features include security functionality allowing the chip to accept runtime code in an encrypted form and the use of a trusted authentication service to validate runtime requests to particular chips and/or users, as well as validate certifications for application SW and S-HW object code before being run, including ensuring that certified code has not been tampered with. Code may be provided/loaded externally to the DLSoC processor, or could be embedded within non-volitile memory within the device.

FIG. 2 further illustrates the topology of the DLSoC processor described. The hardware interfaces, main bus, DMA and MPU are partitioned to the left, with a single bridge to the SDA fabric shown. The SDA bridge allows any SDA-based generated design to be easily integrated to existing topologies. In this case, two levels of SDA subsystem fabric are shown to reach the eFPGA chiplet IPs. Self managed communication between loaded S-HW IP is accomplished through the SDA fabric. In the illustrated topology, flexible I/Os from the subsystem may be connected to the dynamic logic array (DLA) elements that are based upon the SDA eFPGA IPs.

It's noteworthy that once S-HW configurations are loaded into the DLAs, the S-HW interface traffic does not have to pass through the main processor (shown as DLP MPU) to interact with other S-HW IP, and if the DMA and user interfaces are designed to take advantage of SDA data transfer tagging may bypass the MPU altogether.

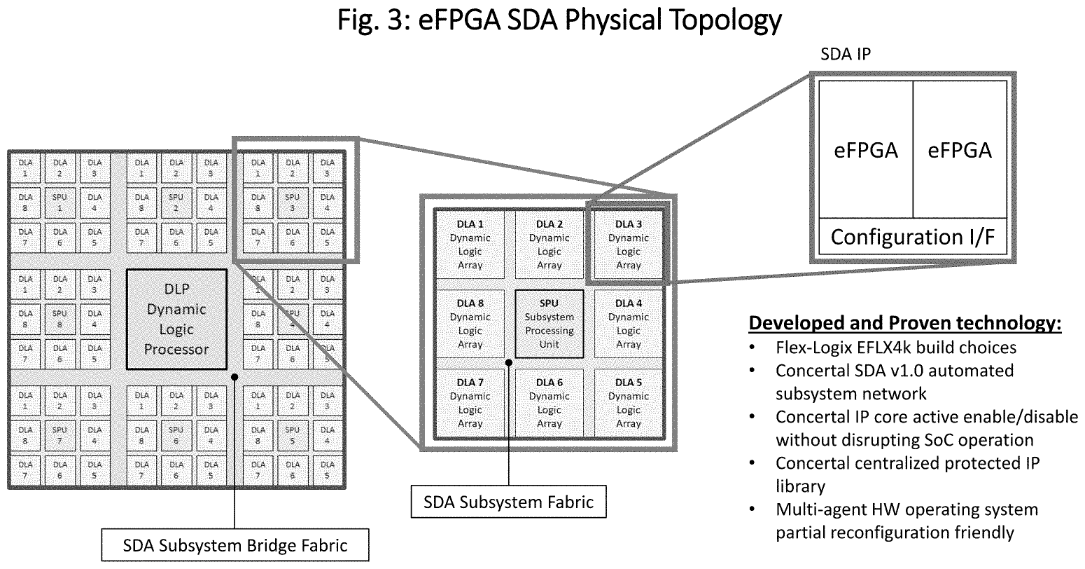

FIG. 3 illustrates a physical topology example for the DLSoC, with DLA eFPGA IPs grouped into subsystems, and subsystems grouped into a 2^{nd} order subsystem. Each DLA shown is an SDA-based IP with auto generated IP wrapper able to incorporate generic data transfer source and sink interfaces, mode control registers, and hardware event wires. One example of an eFPGA IP topology is shown, including two instances of an eFPGA block with simple interface logic for the SDA fabric wrapper. The interface logic provides the signals to dynamically configure eFPGA through the SDA fabric using well understood SDA wrapper signals. In this example, each eFPGA block may be individually configured, but they share the same SDA socket interface. Interconnects between the eFPGA block allow them to be used together in one socket location for expanded gate capacity if desired.

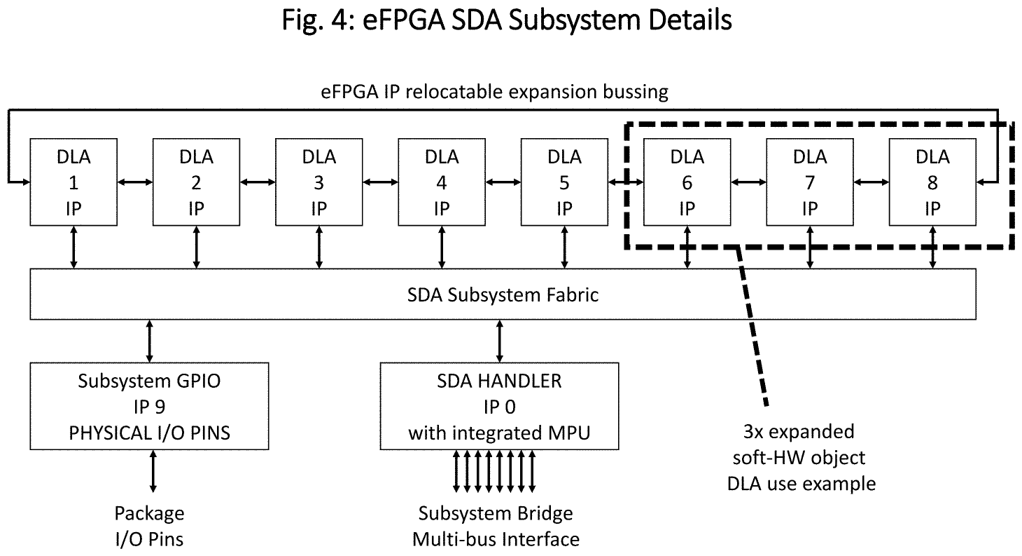

FIG. 4 further illustrates an example of an eFPGA subsystem, including 8 eFPGA IPs in this case. An added feature in this topology compared to the mentioned SDA patent disclosure incorporates additional interconnect bussing between the separate IPs, bypassing the SDA subsystem fabric. This enables multiple eFPGA DLA IPs to be combined together into a larger single eFPGA element, as illustrated in the 3× expanded group box. The interconnect between DLA IPs are uniform in topology, and the last IP loops back to the first, making it possible to group any adjacent DLAs together regardless of configuration position. This uniformity allows loaded S-HW code to be targeted for use onto any available DLAs within any eFPGA subsystem, and also allows multiple instances of instantiations to exist.

Although the DLAs IPs could be designed to incorporate dedicated package I/O pins, a separate general purpose input output (GPIO) IP (9) is shown that provides a way for any DLA to make use of any of the subsystems physical I/O pins.

Also illustrated is the SDA Handler IP, part of each SDA generated subsystem. This handler is expanded to also include an integrated MPU that is able to implement security firewall capabilities and decryption of configuration load data to the DLAs. The handler IP may include optional multi-bus expansions to relieve dataflow bottlenecks between multiple subsystems if required for some specialized performance based applications.

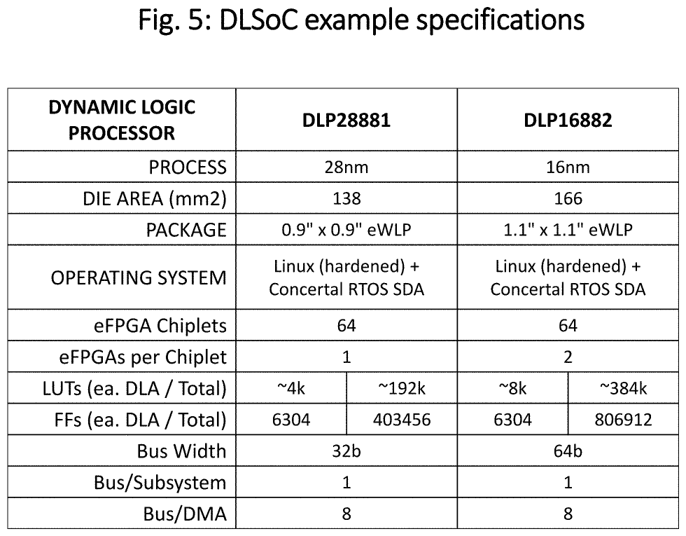

FIG. 5 illustrates a table of two DLSoC part specifications of varying complexities and eFPGA capacity, and is self explanatory.

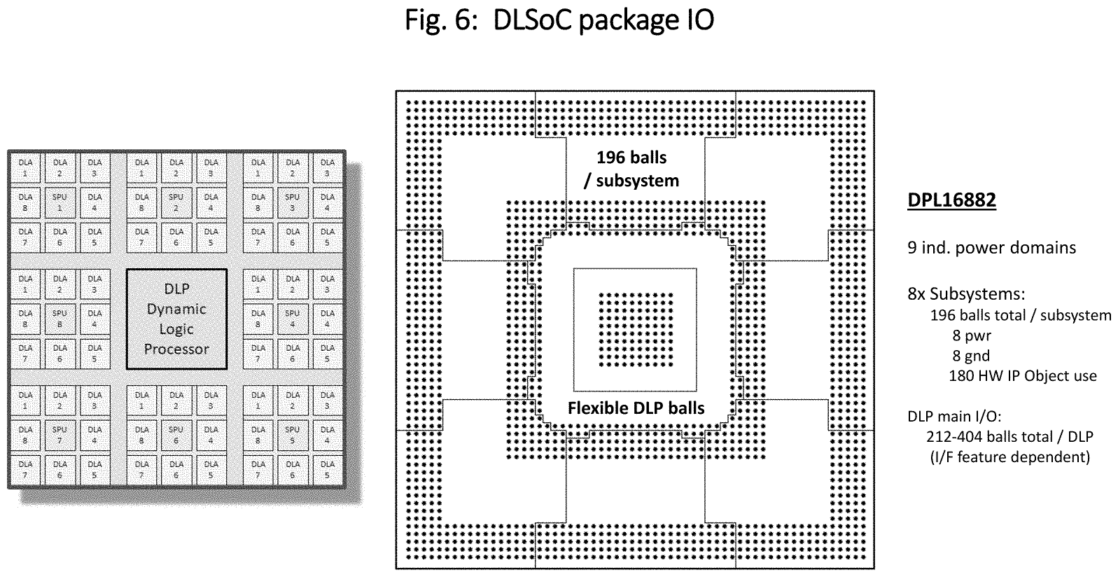

FIG. 6 shows the ball pattern proposed for the DLP16882 part shown in FIG. 5, targeted for an eWLP package.

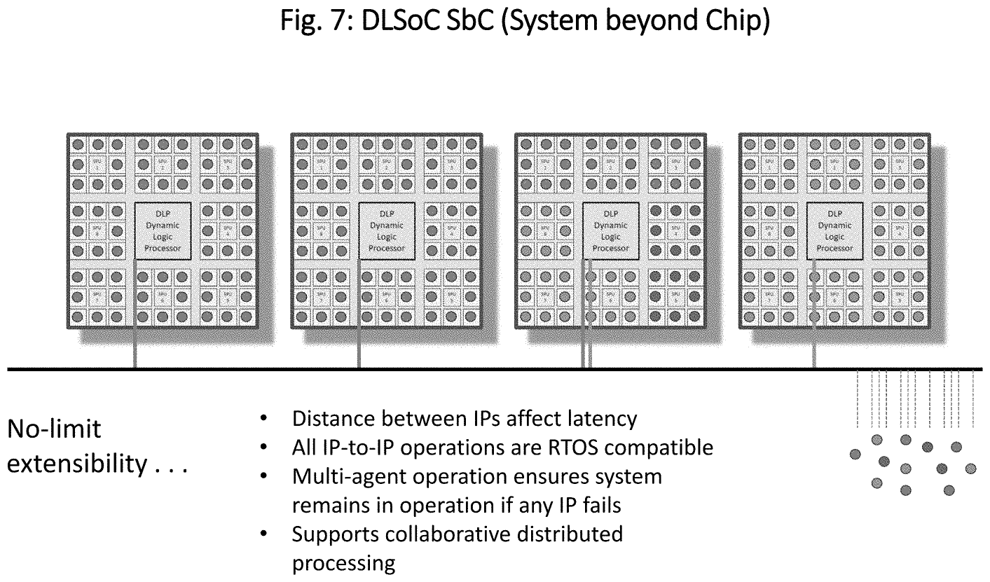

Using the advantages of Network Beyond Chip (NbC) capabilities made available through the use of tagged data SDA features, FIG. 7 shows how eFPGA DLA resources can be grouped together to implement high capacity application needs, including incorporation of distributed application SW and S-HW IP that can work together in a loosely coupled way through the multi-agent event driven operating methods.

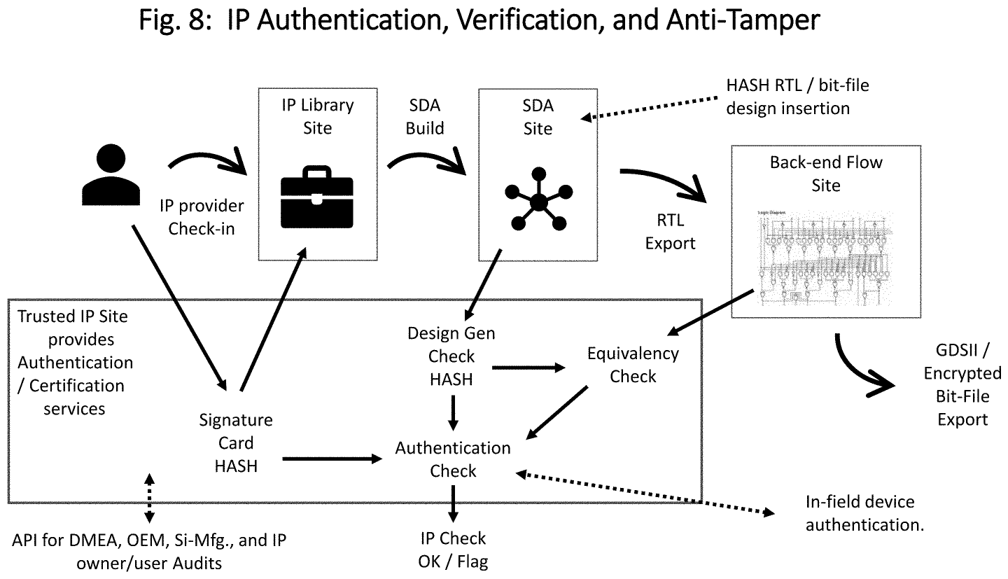

The last FIG. 8 shows additional detail for the trusted IP site, providing IP authentication, verification, and anti-tamper validation of application SW and S-HW object code. When an IP provider creates or changes IP source code into the SDA IP library site, they also create a signature card based upon common HASH methods. When an SDA design is generated, exported designs can check the HASH codes of the IP used against the original signature card within the trusted IP site, authenticating the IP, and all certifications recorded on the site are OK.

When IP source code is compiled or synthesized for use, the source code becomes highly modified, making direct checks of HASH codes impossible. However, in the case of logic synthesis, there are existing equivalency check tools that can be used to ensure the functionality matches the original IP source code functionality. By incorporating equivalency check capability within the flow of checking HASH tags, the modified code can be authenticated against the original source code HASH tag, once again along with any recorded certifications that may be recorded. Further, since SDA based designs automatically incorporate IP wrapper circuitry, the wrapper can generate self test capability using a commonly used gate level scan test, or eFPGA available hardware check. These IP self checks in HW are able to generate a field operational signature that can be registered by the IP distributor that can be registered with the trusted IP source site, allowing in field S-HW checks to be tied all the way back to the original IP providers source code, thus ensuring against anti-tampering of functional SW or S-HW IP at runtime.

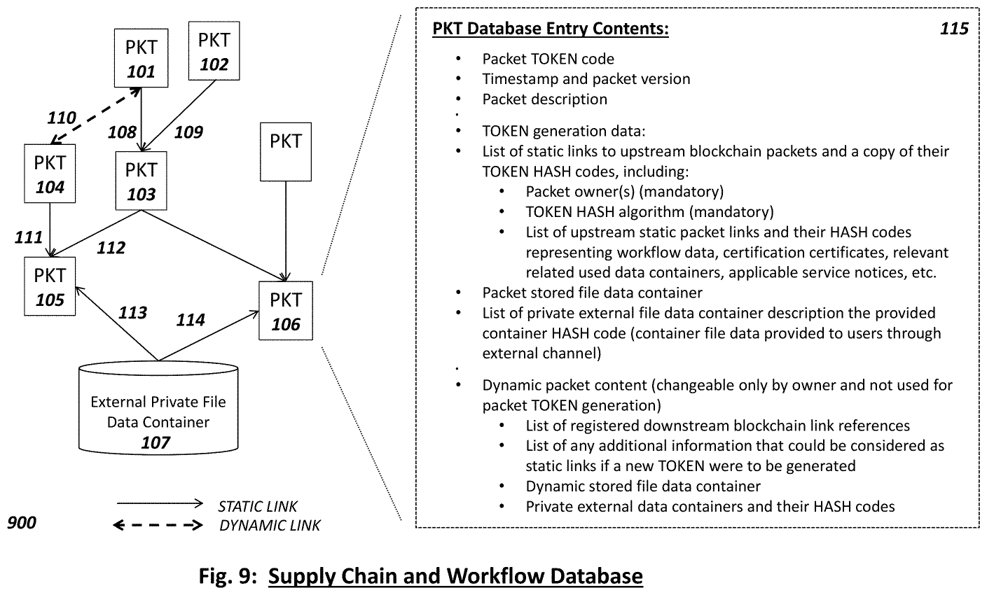

FIG. 9 further illustrates additional details of the use of HASH tags for validating the supply chain and development workflow of hardware devices and runtime code embedded by designers or loaded by device users, represented in a block chain database. Block chain packets represented by a HASH code token are defined with flexible packet database entry support any combination of contents that not only include the token, timestamp, and description, but also additional information as described in the figure that support multiple token HASH generation algorithms, multiple upstream block chain links of prior referenced or reused work deliverables, data file containers that may be stored as part of token packets, private data file containers and their varifyable HASH codes to validate content that is independently shared as part of outside file repository systems, and the support of dynamic packet information that may point to new downstream HASH packet entries such as user bulletins, service requests, or part of a file repository system incorporated as part of the block chain system. New packets can be created from dynamic content to create new verifyable releases of content. It is important to point out that this novel block chain system has generic application appeal, able to be applied to any content or workflow environment.

Workflows for the development of chips and the runtime code they use can be highly complex, requiring the collaboration of many different types of data content, individuals, and organizations that can be difficult to assess the composite trust of. Using the defined block chain to represent all aspects of the development and delivery supply chain provides a mechanism for any user in the flow to quickly determine trust down to the roots of prior work being inherited. For example, certifications can be defined for integrated circuit or software code developers that can be referenced to represent different trust criteria such as code checks, security audits, equivalency checks, or any other workflow deemed important downstream in the development or supply chain. The system of use includes the ability for users to define their own criteria of trust, such as their trusted partners, required certifications for specific types of work, dynamically defined alerts that may have developed since block chain packet data was used within the flow, or other aspects important to the user such as areas to flag that might be observed as trust concerns. Once defined, an analysis of the entire supply chain can be automatically analyzed by users to determine a level of trust of used deliverables, and a list of trust concerns to look at more closely in order to gain the trust level required. The use of certificate and trust analysis may be used to define a legally binding level of trust of users that may also facilitate business transactions.

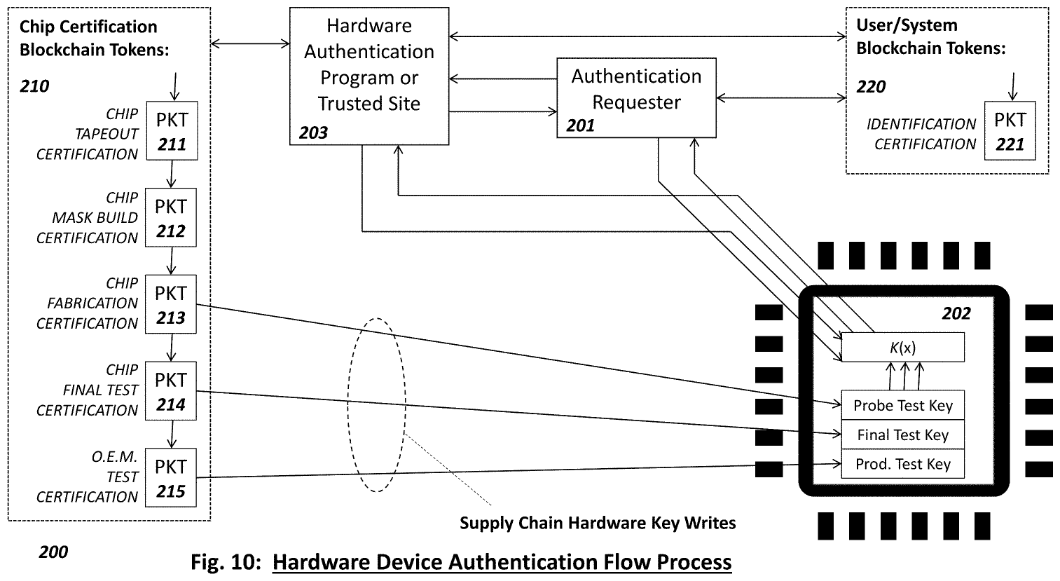

FIG. 10 further illustrates how the blockchain HASH codes for the development flow may be used with hardware devices 202 such as the DLSoC Processor described in this invention. 202 illustrates a hardware device that includes one or more supply chain keys into the hardware design. Various supply chain steps 211-215 may each generate codes that can be used to program trust keys within the hardware device. Users represented by independently authenticated certifications 221 may request validation of hardware devices 202 directly or optionally through the use of a program or trusted site 203. Device 202 generates response codes K(x) from received request codes using internal trust keys, validated through access use of the supply block chain 210 for authentication. Hardware Authentication Program or Trusted Site 203 may optionally incorporate further algorithmic protection mechanisms also supported by the K(x) algorithm chosen for use in the hardware design.

Loadable runtime code may also be similarly validated through the use of a loadable program block chain, utilize industry acceptable methods of encryption for loading, or may even be encrypted for use only by particular devices and users through the use of the Chip Certification Blockchain 210 or User/System Blockchain 220.

Noteworthy is that the hardware device and executable program code authentication method described may be utilized by OEMs and Users in a variety of ways. For example, systems can be architected to allow users to perform authentications directly, using provided programs, through trusted sites, or enabling hardware system features to be validated for particular users as well. Additionally, field use models may decide to utilize the authentication capabilities however necessary to meet their trust criteria. Additional features that may be made available to users through the use of the block chain site would to provide users with additional dynamic data that might become available since the hardware device or runtime code was released for use. The entire development flow and supply block chain may be examined to uncover new dynamic link alerts for any points in the supply chain that might appear as well, ensuring new trust issues can be passed along if necessary.

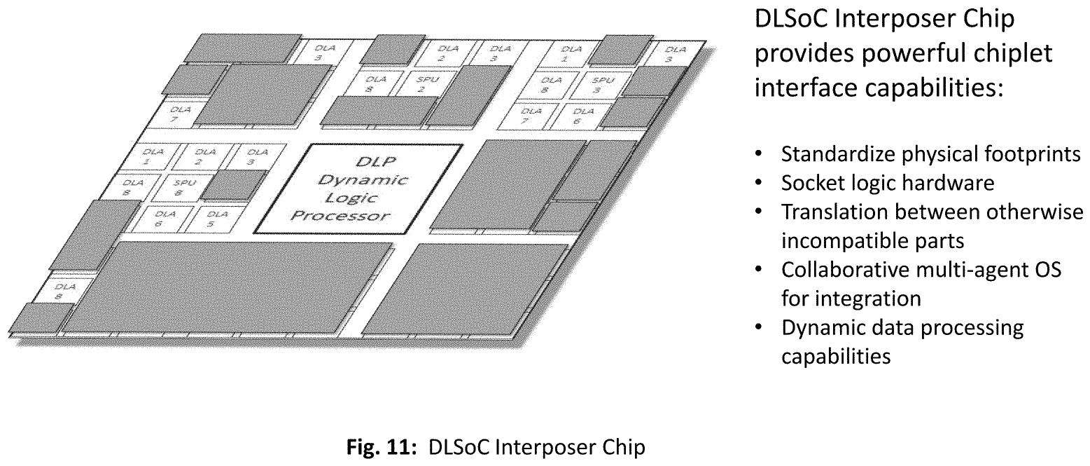

The Dynamic Logic SoC Processor described is a novel secure processor that utilizes loosely-coupled FPGA blocks through the use of a smart connect self-managed integration fabric that is able to accept runtime SW and Soft-HW agents can be loaded and run dynamically on demand. The described DLSoC SbC features and grid pattern layout is also able to support 2.5/3D manufacturing base interposer chip architecture needs that require accepting chiplets that need to functionally integrated together, where added die may use soft-HW programs for use by eFPGA IP to act as functional translation layer between chiplets, allowing otherwise functionally incompatible devices to easily work together as a System in Package (SiP) as illustrated in FIG. 11.

1. A blockchain with packet contents comprised of upstream links for guaranteed provenance of workflow, downstream links for post token generation dynamic content inclusion, and private and public data container content.

2. A dynamic logic processor comprised of embedded FPGA IP and application processor able to accept application software and soft hardware programs with key HASH codes for authenticating provenance of hardware and programs through the use of a development and supply flow blockchain.
